(19) United States
(12) Patent Application Publication
(10) Pub. No.: US 2013/0031631 A1
(43) Pub. Date: Jan. 31, 2013

(54) DETECTION OF UNAUTHORIZED DEVICE ACCESS OR MODIFICATIONS

(71) Applicants: Rod D. Waltermann, Rougemont, NC (US); David Rivera, Durham, NC (US)

(72) Inventors: Rod D. Waltermann, Rougemont, NC (US); David Rivera, Durham, NC (US)

(73) Assignee: Lenovo (Singapore) Pte. Ltd., Singapore (SG)

(21) Appl. No.: 13/189,911

(22) Filed: Jul. 25, 2011

(51) Int. Cl. G06F 21/00

(52) U.S. Cl. 726/23

(57) ABSTRACT

Devices, methods and products are described that provide for recording an unauthorized event, such as rooting, on an information handling device. One aspect provides a method comprising determining whether at least one unauthorized event has occurred on an information handling device; setting at least one unauthorized event flag stored on the information handling device responsive to an unauthorized event; and allowing external access to the at least one unauthorized event flag. Other embodiments and aspects are also described herein.

### BACKGROUND

Computing device manufacturers provide users with limited device privileges, restricting access to device files, hardware and software applications. Limiting user privileges protects the integrity of devices and facilitates more effective technical support. Nonetheless, certain users seek to gain increased access privileges through processes termed “rooting” or “jailbreaking” Rooting a device allows a user to gain root or superuser access to all system files, essentially allowing full control over a device, access intended for the original device manufacturers. Current solutions to prevent rooting focus on making it more difficult to gain root access. However, this has not stopped or even slowed down this activity. Instead, these efforts have developed into a cycle of escalating tactics by manufacturers attempting to protect their devices competing against users seeking to root them.

### BRIEF SUMMARY

In summary, one aspect provides an information handling device comprising: one or more processors; wherein, responsive to execution of computer program instructions accessible to the one or more processors, the one or more processors are configured to: determine whether at least one unauthorized event has occurred on the information handling device; set at least one unauthorized event flag responsive to an unauthorized event; and allow external access to the at least one unauthorized event flag.

Another aspect provides a method comprising: determining whether at least one unauthorized event has occurred on an information handling device; setting at least one unauthorized event flag stored on the information handling device responsive to an unauthorized event; and allowing external access to the at least one unauthorized event flag.

A further aspect provides a program product comprising: a storage medium having program code embodied therewith, the program code comprising: program code configured to determine whether at least one unauthorized event has occurred on an information handling device; program code configured to set at least one unauthorized event flag stored on the information handling device responsive to an unauthorized event; and program code configured to allow external access to the at least one unauthorized event flag.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of recording a rooting event according to an embodiment.

FIG. 2 illustrates an example of accessing the root status of an information handling device according to an embodiment.

FIG. 3 provides an example root detection process according to an embodiment.

FIG. 4 illustrates an example circuitry of an information handling device.

FIG. 5 illustrates another example circuitry of an information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation.

Root access provides an information handling device user authorization to manage the root, or the top-level directory, of the device file system. This essentially provides full control over a device. Consumers are generally only granted “guest” level privileges, which provide a high level of functionality, but do not allow for full control over all aspects of a particular device.

It is well known that certain device users are able to gain root access to their devices by “rooting” or “jailbreaking” their devices. In general, jailbreaking refers to obtaining root access on iOS® devices, such as an iPhone® or iPad®, while rooting refers to obtaining root access on an Android® based device. iPhone® and iPad® are registered trademarks of Apple Inc. Android® is a trademark of Google Inc. in the United States and other countries. IOS® is a registered trademark of Cisco in the United States and other countries. However, the terms rooting and jailbreaking are considered synonymous herein. In general, rooting is a method to circumvent the firmware protections put on the device by the manufacturer and gain full access to the device. There is a multitude of methods for rooting an information handling device, each specific for the particular operating system powering the device.

Exemplary information handling devices according to embodiments may include devices operating through mobile operating systems including the Android®, Blackberry®, Windows Phone 7®, iOS® operating systems, and any other operating system capable of operating an information handling device. Blackberry® is a registered trademark of Research In Motion Limited. Windows® and Windows Phone 7® are registered trademarks of Microsoft Corporation.

Reasons for rooting a device include running applications on the device not available otherwise, running applications in unauthorized modes, customizing device themes and features, modifying the performance of certain device functions, such as processor, kernel, and battery behavior. However, there are certain consequences for rooting a device. A primary example is increased vulnerability to security risks. Additional consequences include loss of manufacturer warranty, loss of functionality or data, and causing the device to become effectively inoperative.

Device manufacturers have attempted to prevent users from rooting their devices with little or no success. For example, manufacturers have added security features to prevent rooting, including providing fixes for security weaknesses, configuring devices to respond to unsigned firmware or software applications, and denying certain features for rooted devices. Designing and implementing these security features adds significantly to development time and costs. In addition, it is highly likely that users intent on rooting a device will eventually find their way around any enhanced security features. As such, manufacturers may benefit from a system that focuses on detecting and reporting device rooting in conjunction with existing preventative security features.

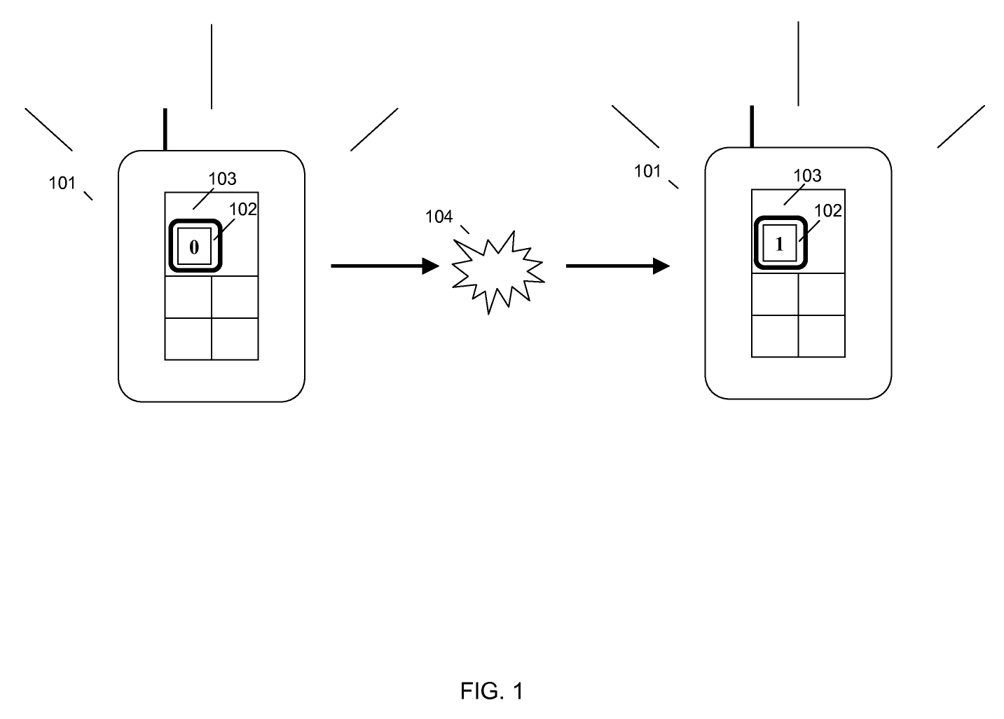

Embodiments provide for recording an unauthorized access event on an information handling device, including a rooting event such as unauthorized device access, modifications or software installations. According to embodiments, a detection means may be stored on an information handling device such that the detection means may be modified to indicate the device has been rooted in response to a rooting event. In FIG. 1, therein is depicted an example of recording a rooting event according to an embodiment. An unauthorized event bit 102 is stored through firmware 103 running on the information handling device 101. Non-restrictive examples of information handling devices include, but are not limited to, cell phones (e.g., smartphones), tablet computing devices, embedded computing devices, and gaming consoles. Initially, the unauthorized event bit 102 is set to zero to indicate that the device has not experienced an unauthorized event. When an unauthorized event 104 is detected, the unauthorized event bit 102 is set to one to indicate that the device has experienced an unauthorized event. According to embodiments, unauthorized events may be comprised of any event wherein a user gains unauthorized access to the information handling device or makes unauthorized changes to the device, its systems, or software.

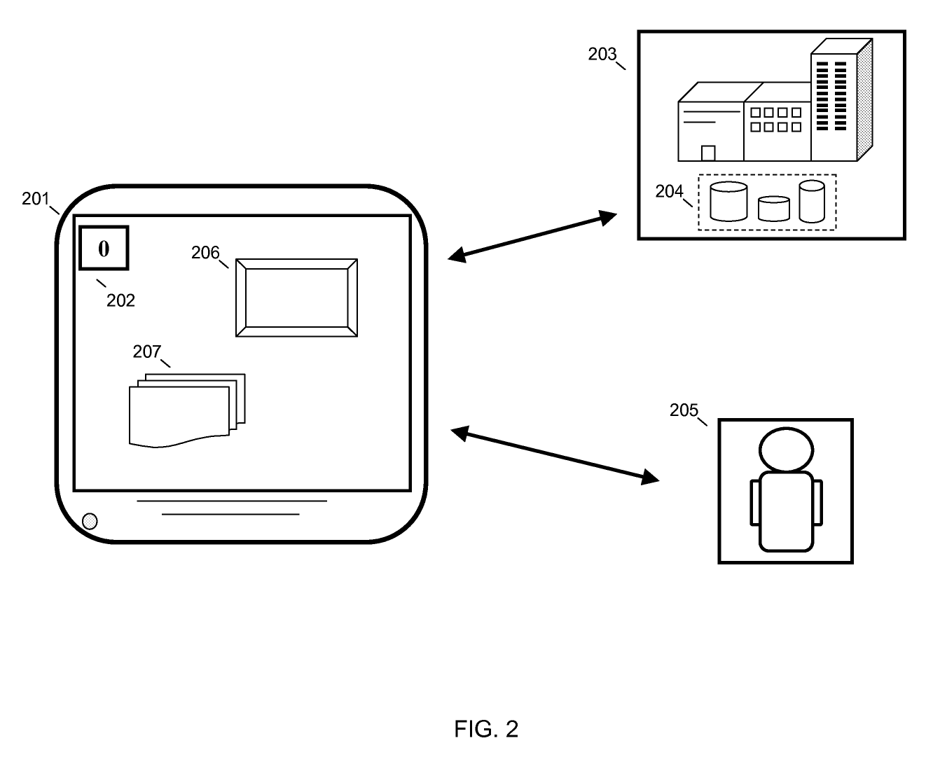

Referring to FIG. 2, therein is depicted an example of accessing the root status of an information handling device according to an embodiment. The root status flag 202 of a mobile information handling device 201 has been set, indicating that the device 201 has been rooted. As illustrated in FIG. 2, the device manufacturer 203 may maintain a database 204 of devices with a record for each device, including a field indicating the root status of each device. When a status transmission event occurs, the value of the root status flag 202 of the device 201 may be transmitted to the database 204. Illustrative and non-restrictive examples of status transmission events include, but are not limited to, device startup and change in the root status flag 202 value. Transmission of the root status flag 202 value may occur, for example, over a telecommunications network or the Internet.

In addition, the device manufacturer 203 or technical support 205 may query the device 201 at specified intervals to determine the root status flag 202 value. For example, the device 201 may be queried at set time intervals, after certain device events, or when a user contacts the manufacturer 203 or technical support 205. As shown in FIG. 2, a management application 206 running on the device 201 may monitor for system updates, including the root status flag 202. The management application 206 may be accessed, for example, by technical support 205 or other software applications, to determine the value of the root status flag 202. Also depicted in FIG. 2, is an API 207 that monitors the root status flag 202 value. According to embodiments, any firmware, software application, or third party web site in communication with the device may call the API 207 and obtain the root status flag 202 information. As a non-limiting example, a third party web site interacting with the device 201 may deny or limit access to rooted devices as determined through the API 207, the management application 206, or some combination thereof.

Many low-level information handling device functions operate through firmware, such as radio communication and display functions. Embodiments provide that one or more bits may be reserved in a secure firmware location that serve as a an unauthorized event or root detection flag. As a non-limiting example, the unauthorized event flag may be reserved in the embedded controller firmware of an information handling device configured according to embodiments. In addition, embodiments provide that the unauthorized event flag may be stored in a non-volatile memory location, a location that may not be easily accessed by a device user. According to embodiments, the unauthorized event flag may be stored such that once the unauthorized event flag has been set, it may remain set even if the software on the device has been reset. Thus, a user may not have a method to reset the unauthorized event flag after it has been set by the device. Although the unauthorized event flag has been described herein as a binary value (e.g., zero equals device has not been rooted and one equals device has been rooted), it is not so limited. Embodiments provide that the unauthorized event flag may be comprised of more than one bit and may be used to store additional information, including, but not limited to, date and time information and data indicating effected device functions or applications.

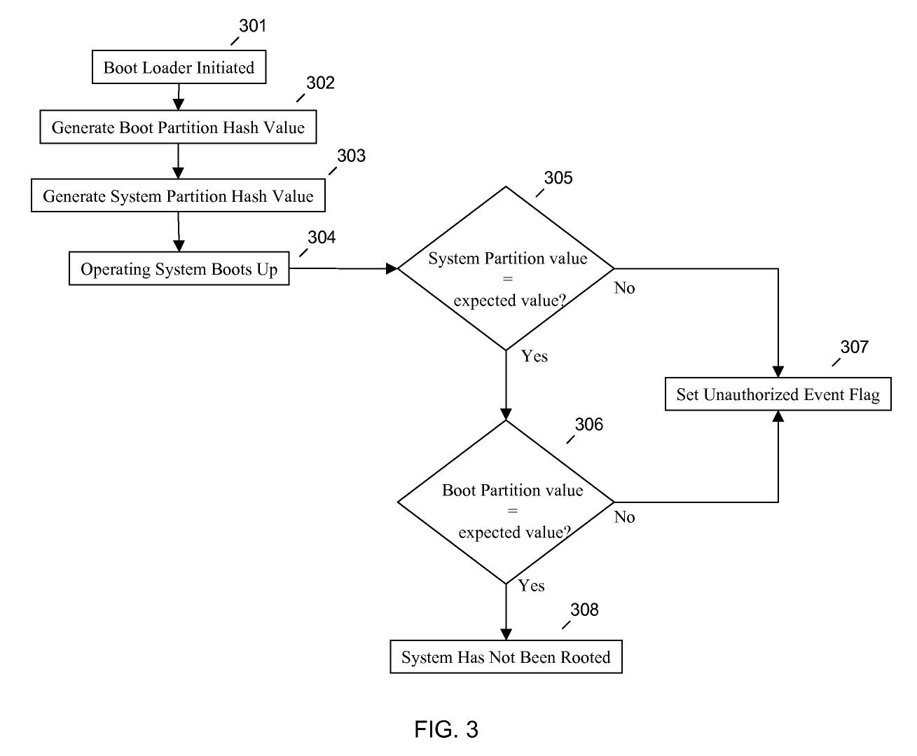

An illustrative and non-restrictive example information handling device is a cell phone, or “smartphone”, powered by the Android® operating system. Referring to FIG. 3, therein is provided a flow diagram of an example process for determining whether an Android® device has been rooted according to an embodiment. The boot loader is initiated 301, and hash values for the boot partition 302 and the system partition 303 are generated. The operating system, for example, an Android® Linux® layer, boots up 304 and the boot loader checks whether the system partition hash value matches the expected value 305. Linux® is a registered trademark of Linus Torvalds. Embodiments provide that the expected value may be a signed value, which may be a more secure value. If the system partition value does not equal the expected value, then the unauthorized event flag is set 307.

As illustrated in FIG. 3, the boot partition hash value is checked against the expected value 306. If the boot partition hash value does not match the expected value, then the system has not been rooted 308; otherwise, the system has been rooted and the unauthorized event flag is set 307. Although the example embodiment depicted in FIG. 3 is an Android® device, embodiments are not so limited, as any information handling device capable of being configured to provide an accessible unauthorized event flag as described herein may be used.

Information handling devices are not static devices that do not change. Users will invariably install operating system and driver updates as well as multiple applications. Embodiments provide for distinguishing between authorized and unauthorized device modifications. According to embodiments, the manufacturer may digitally sign authorized changes such that when a hash value is checked against a signed hash value, the values will match. Embodiments provide that authorized device changes, including, software, firmware, and operating system upgrades, may be digitally signed such that installation on an information handling device will not trigger a change in an unauthorized event flag.

Many security architectures are utilized by information handling devices to safeguard the integrity of devices and the software and content accessed by devices. Public key infrastructure (PKI) is a highly used security architecture used to verify and authenticate information exchanged between a device and a third party, such as software downloaded over the Internet or a device upgraded obtained over a telecommunications network. In general, PKI utilizes a public key and private key pair for authentication. Embodiments may use a form of PKI to determine whether a device has been rooted and whether an update is authorized or not. According to a non-limiting example, when a manufacturer builds a device image, a private key is used to sign the image. As part of the signing process, the hash value for the image is determined and cryptographically encrypted using the private key, which may only be unlocked with the public key. Embodiments may store the PKI information on the device, including the hash value and the public key, along with a firmware image. According to embodiments, the boot loader may compute the hash value when it initiates and decrypt the signed value obtained when the image was updated. If the hash value and the signed value match, the device has not been rooted. On the other hand, the device may have been compromised (i.e., rooted) if the values have not been matched or if the image file may not be located.

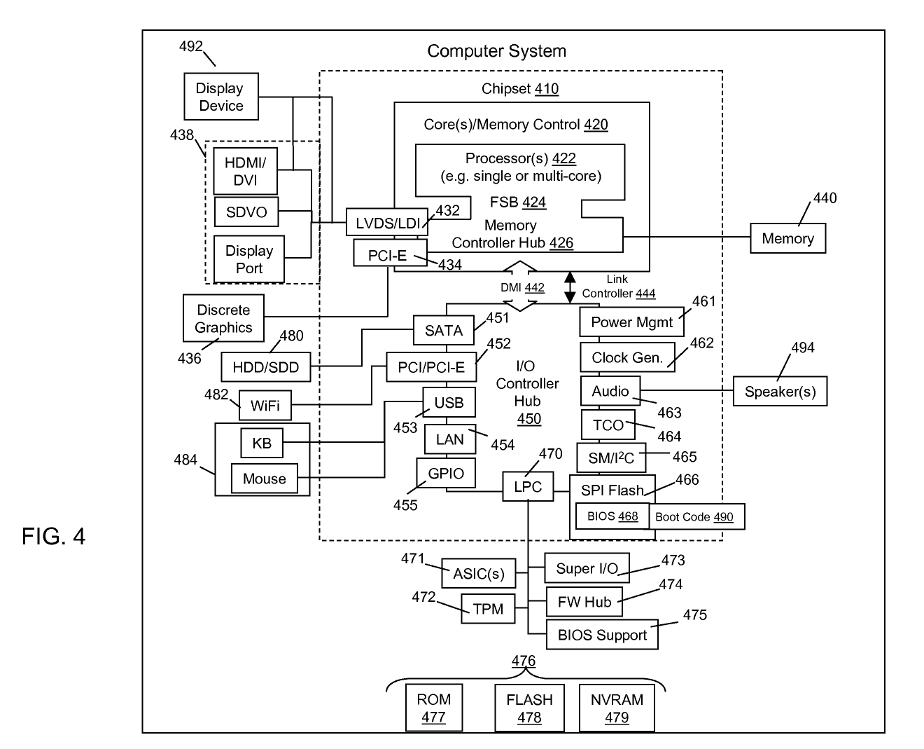

While various other circuits, circuitry or components may be utilized, FIG. 4 depicts a block diagram of one example of information handling device circuits, circuitry or components. The example depicted in FIG. 4 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 4.

The example of FIG. 4 includes a so-called chipset 410 (a group of integrated circuits, or chips, that work together, chipsets) with an architecture that may vary depending on manufacturer (for example, INTEL, AMD, ARM, etc.). The architecture of the chipset 410 includes a core and memory control group 420 and an I/O controller hub 450 that exchanges information (for example, data, signals, commands, et cetera) via a direct management interface (DMI) 442 or a link controller 444. In FIG. 4, the DMI 442 is a chip-to-chip interface (sometimes referred to as being a link between a “northbridge” and a “southbridge”). The core and memory control group 420 include one or more processors 422 (for example, single or multi-core) and a memory controller hub 426 that exchange information via a front side bus (FSB) 424; noting that components of the group 420 may be integrated in a chip that supplants the conventional “northbridge” style architecture.

In FIG. 4, the memory controller hub 426 interfaces with memory 440 (for example, to provide support for a type of RAM that may be referred to as “system memory” or “memory”). The memory controller hub 426 further includes a LVDS interface 432 for a display device 492 (for example, a CRT, a flat panel, a projector, et cetera). A block 438 includes some technologies that may be supported via the LVDS interface 432 (for example, serial digital video, HDMI/DVI, display port). The memory controller hub 426 also includes a PCI-express interface (PCI-E) 434 that may support discrete graphics 436.

In FIG. 4, the I/O hub controller 450 includes a SATA interface 451 (for example, for HDDs, SDDs, 480 et cetera), a PCI-E interface 452 (for example, for wireless connections 482), a USB interface 453 (for example, for input devices 484 such as a digitizer, keyboard, mice, cameras, phones, storage, other connected devices, et cetera.), a network interface 454 (for example, LAN), a GPIO interface 455, a LPC interface 470 (for ASICs 471, a TPM 472, a super I/O 473, a firmware hub 474, BIOS support 475 as well as various types of memory 476 such as ROM 477, Flash 478, and NVRAM 479), a power management interface 461, a clock generator interface 462, an audio interface 463 (for example, for speakers 494), a TCO interface 464, a system management bus interface 465, and SPI Flash 466, which can include BIOS 468 and boot code 490. The I/O hub controller 450 may include gigabit Ethernet support.

The system, upon power on, may be configured to execute boot code 490 for the BIOS 468, as stored within the SPI Flash 466, and thereafter processes data under the control of one or more operating systems and application software (for example, stored in system memory 440). An operating system may be stored in any of a variety of locations and accessed, for example, according to instructions of the BIOS 468. As described herein, a device may include fewer or more features than shown in the system of FIG. 4.

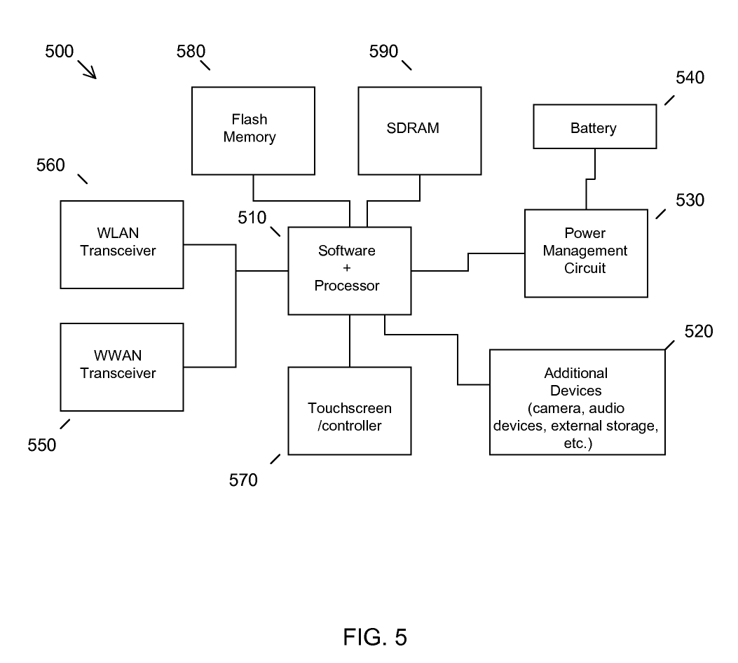

For example, referring to FIG. 5, with regard to smart phone and/or tablet circuitry 500, an example includes an ARM based system (system on a chip) design, with software and processor(s) combined in a single chip 510. Internal busses and the like depend on different vendors, but essentially all the peripheral devices (520) may attach to a single chip 510. In contrast to the circuitry illustrated in FIG. 5, the tablet circuitry 500 combines the processor, memory control, and I/O controller hub all into a single chip 510. Also, ARM based systems 500 do not typically use SATA or PCI or LPC. Common interfaces for example include SDIO and I2C. There are power management chip(s) 530, which manage power as supplied for example via a rechargeable battery 540, which may be recharged by a connection to a power source (not shown), and in the at least one design, a single chip, such as 510, is used to supply BIOS like functionality and DRAM memory.

ARM based systems 500 typically include one or more of a WWAN transceiver 550 and a WLAN transceiver 560 for connecting to various networks, such as telecommunications networks and wireless base stations. Commonly, an ARM based system 500 will include a touchscreen 570 for data input and display. ARM based systems 500 also typically include various memory devices, for example flash memory 580 and SDRAM 590.

Embodiments may be implemented in one or more information handling devices configured appropriately to execute program instructions consistent with the functionality of the embodiments as described herein. In this regard, FIGS. 4-5 illustrate non-limiting examples of such devices and components thereof. While mobile computing systems such as tablet computers, laptop computers, and smart phones have been specifically mentioned as examples herein, embodiments may be implemented using other systems or devices as appropriate.

As will be appreciated by one skilled in the art, various aspects may be embodied as a system, method or computer (device) program product. Accordingly, aspects may take the form of an entirely hardware embodiment or an embodiment including software that may all generally be referred to herein as a “circuit,” “module” or “system.” Furthermore, aspects may take the form of a computer (device) program product embodied in one or more computer (device) readable medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device comprising:
one or more processors;
a display device accessible by the one or more processors;
a memory in operative connection with the one or more processors;
wherein, responsive to execution of program instructions accessible to the one or more processors, the one or more processors are configured to:
determine whether at least one unauthorized event has occurred on the information handling device;
set at least one unauthorized event flag responsive to an unauthorized event; and
allow external access to the at least one unauthorized event flag.

2. The information handling device of claim 1, wherein the information handling device comprises a cell phone.

3. The information handling device of claim 1, wherein the at least one unauthorized event comprises rooting the information handling device.

4. The information handling device of claim 1, wherein the at least one unauthorized event comprises detection of installation of unauthorized software on the information handling device.

5. The information handling device of claim 1, wherein the at least one unauthorized event flag comprises at least one bit reserved in firmware running on the information handling device.

6. The information handling device of claim 5, wherein the firmware running on the information handling device comprises embedded controller firmware.

7. The information handling device of claim 1, wherein the at least one unauthorized event flag is transmitted externally responsive to being set.

8. The information handling device of claim 7, further communicating to an external database:
the external database comprising:
at least one database configured to store information associated with the information handling device; and
at least one receiver configured to receive a transmitted unauthorized event flag;
wherein the at least one receiver updates the at least one database for the information handling device response to receiving a transmitted unauthorized event flag.

9. The information handling device of claim 1, wherein determining whether at least one unauthorized event has occurred on the information handling device comprises determining whether at least one partition hash value matches at least one signed value.

10. The information handling device of claim 9, wherein the at least one partition hash value comprises at least one system partition hash value and at least one boot partition hash value.

11. A method comprising:
determining whether at least one unauthorized event has occurred on an information handling device;
setting at least one unauthorized event flag stored on the information handling device responsive to an unauthorized event; and
allowing external access to the at least one unauthorized event flag.

12. The method of claim 11, wherein the information handling device comprises a cell phone.

13. The method of claim 11, wherein the at least one unauthorized event comprises rooting the information handling device.

14. The method of claim 11, wherein the at least one unauthorized event comprises detection of installation of unauthorized software on the information handling device.

15. The method of claim 11, wherein the at least one unauthorized event flag comprises at least one bit reserved in firmware running on the information handling device.

16. The method of claim 15, wherein the firmware running on the information handling device comprises embedded controller firmware.

17. The method of claim 11, wherein the at least one unauthorized event flag is transmitted externally responsive to being set.

18. The method of claim 17, wherein the information handling device is configured to communicate with at least one external database, the at least one external database comprising:
at least one database configured to store information associated with the information handling device; and
at least one receiver configured to receive a transmitted unauthorized event flag;
wherein the at least one receiver updates the at least one database for the information handling device response to receiving a transmitted unauthorized event flag.

19. The method of claim 1, wherein determining whether at least one unauthorized event has occurred on the information handling device comprises determining whether at least one partition hash value matches at least one signed value.

20. A program product comprising:
a storage medium having program code embodied therewith, the program code comprising:
program code configured to determine whether at least one unauthorized event has occurred on an information handling device;
program code configured to set at least one unauthorized event flag stored on the information handling device responsive to an unauthorized event; and
program code configured to allow external access to the at least one unauthorized event flag.
